(19) United States
(12) Patent Application Publication
(10) Pub. No.: US 2018/0342884 A1
(43) Pub. Date: Nov. 29, 2018

(54) ELECTRIC CHARGER SENSITIVE TO STATE OF RECHARGEABLE OBJECT

(71) Applicant: HON HAI PRECISION INDUSTRY CO., LTD., New Taipei (TW)

(72) Inventor: YU-PING CHEN, New Taipei (TW)

(21) Appl. No.: 15/618,073

(22) Filed: Jun. 8, 2017

(30) Foreign Application Priority Data
May 27, 2017 (TW) 106117767

(51) Int. Cl. H02J 7/00

(52) U.S. Cl. CPC H02J 7/0029; H02J 7/0047; H02J 7/0068; H02J 7/0045

(57) ABSTRACT

A electric charger comprises an electric current inputting end, at least one electric current outputting end, a switching circuit, a micro programmed control unit with a smoke concentration preset range and a temperature preset range, a smoke sensor sensing smoke transmitting a smoke concentration value to the micro programmed control unit and a temperature sensor sensing temperature transmitting a temperature value to the micro programmed control unit. The micro programmed control unit contrasts the smoke concentration value against the smoke concentration preset range and contrasting the temperature value against the temperature preset range for controlling the at least one electric current outputting end to be on or off.

### FIELD

The subject matter herein generally relates to an electric charger.

### BACKGROUND

With the development of electronic products, more and more electronic products need to use the electric charger, however, accidents are frequent. Improving the safety of the electric charger is necessary.

### BRIEF DESCRIPTION OF THE DRAWING

Implementations of the present technology will now be described, by way of example only, with reference to the attached figure.

The FIGURE is a schematic diagram of an electric charger in accordance with an exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawing is not necessarily to scale, and the proportions of certain parts may be exaggerated to illustrate details and features of the present disclosure better. The disclosure is illustrated by way of example and not by way of limitation. It should be noted that references to “an” or “one” exemplary embodiment in this disclosure are not necessarily to the same exemplary embodiment, and such references mean “at least one.”

The term “comprising” when utilized, means “including, but not necessarily limited to”; it specifically indicates open-ended inclusion or membership in the so-described combination, group, series, and the like.

An electric charger is disclosed, the electric charger comprising:

an electric current inputting end being configured for being connected to an external circuit;

at least one electric current outputting end being configured for being connected to at least one electronic product;

a switching circuit, an electric current of the external circuit being varied voltage magnitude and current magnitude by the switching circuit, and being outputted to the at least one electronic product by the at least one electric current outputting end; and

a micro programmed control unit with a smoke concentration preset range and a temperature preset range;

a smoke sensor sensing smoke, generating a smoke concentration value, and transmitting the smoke concentration value to the micro programmed control unit; and

a temperature sensor sensing temperature, generating a temperature value, and transmitting the temperature value to the micro programmed control unit, and the micro programmed control unit contrasting the smoke concentration value against the smoke concentration preset range and contrasting the temperature value against the temperature preset range for controlling the at least one electric current outputting end to be on or off.

When the smoke concentration value is outside the smoke concentration preset range, or the temperature value is outside the temperature preset range, the micro programmed control unit controls and turns off each electric current outputting end.

When the smoke concentration value is in the smoke concentration preset range, and the temperature value is in the temperature preset range, the micro programmed control unit does not turn off each electric current outputting end.

The micro programmed control unit is connected to Internet and wireless network.

The electric charger further comprises an Ethernet port connected to the micro programmed control unit, and Internet is connected to the electric charger by the Ethernet port.

The electric charger further comprises a WI-FI module connected to the micro programmed control unit, and wireless network is connected to the electric charger by the WI-FI module.

The electric charger further comprises a loudspeaker connected to the micro programmed control unit.

The micro programmed control unit transmits a signal of an operational state of the charge to the loudspeaker, and the loudspeaker outputs the signal audibly.

The electric charger further comprises a microphone connected to the micro programmed control unit.

The microphone receives a voice of user, generates a controlling signal, and transmits the controlling signal to the micro programmed control unit for controlling the electric current outputting end to be on or off.

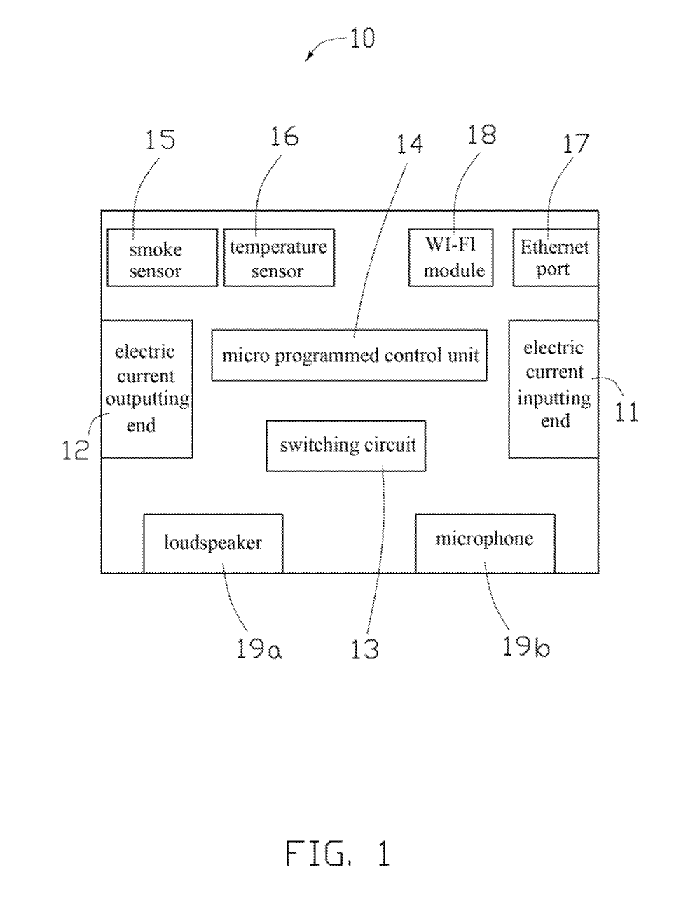

Referring to FIG. 1, an electric charger 10 is provided. The electric charger 10 comprises an electric current inputting end 11, at least one electric current outputting end 12, a switching circuit 13, a micro programmed control unit 14, a smoke sensor 15, and a temperature sensor 16.

The electric current inputting end 11 is configured to be connected to an external circuit. An electric current of the external circuit is inputted into the electric charger 10 by electric current inputting end 11. A part of the electric current of the external circuit is used to supply the micro programmed control unit 14, the smoke sensor 15, and the temperature sensor 16. Another part of the electric current of the external circuit is outputted in varying voltage and current magnitude by the switching circuit 13 to at least one electronic product by the at least one electric current outputting end 12.

The micro programmed control unit 14 can be a single chip microcomputer. The micro programmed control unit is connected to Internet and wireless network. A smoke concentration preset range and a temperature preset range are set in the micro programmed control unit 14.

The smoke sensor 15 senses smoke, generates a smoke concentration value, and transmits the smoke concentration value to the micro programmed control unit 14. The micro programmed control unit 14 contrasts the smoke concentration value against the smoke concentration preset range.

The temperature sensor 16 senses temperature, generates a temperature value, and transmits the temperature value to the micro programmed control unit 14. The micro programmed control unit 14 contrasts the temperature value against the temperature preset range.

When the smoke concentration value is outside the smoke concentration preset range, or the temperature value is outside the temperature preset range, the micro programmed control unit 14 turns off the electric current outputting end 12.

When the smoke concentration value is in the smoke concentration preset range, and the temperature value is in the temperature preset range, the micro programmed control unit 14 does not turn off the electric current outputting end 12.

The electric charger 10 can further comprise an Ethernet port 17. Internet is connected to the electric charger 10 by the Ethernet port 17. The Ethernet port 17 is connected to the micro programmed control unit 14. The micro programmed control unit 14 transmits an operational state of the electric charger 10 to Internet, a computer or a cell phone by the Ethernet port 17.

The electric charger 10 can further comprise a WI-FI module 18. The WI-FI module 18 is connected to the micro programmed control unit 14. Wireless network is connected to the electric charger 10 by the WI-FI module 18. The operational state of the electric charger 10 can also be transmitted to a computer or a cell phone by the WI-FI module 18.

The electric charger 10 can further comprise a loudspeaker 19a. The loudspeaker 19a is connected to the micro programmed control unit 14. The micro programmed control unit 14 transmits a signal of an operational state of the charge 10 to the loudspeaker 19a, and the loudspeaker 19a outputs the signal audibly.

The electric charger 10 can further comprise a microphone 19b. The microphone 19b is connected to the micro programmed control unit 14. The microphone 19b receives a voice of user, generates a controlling signal, and transmits the controlling signal to the micro programmed control unit 14 for controlling the electric current outputting end 12 to be on or off.

It is to be understood, even though information and advantages of the present exemplary embodiments have been set forth in the foregoing description, together with details of the structures and functions of the present exemplary embodiments, the disclosure is illustrative only; changes may be made in detail, especially in matters of shape, size, and arrangement of parts within the principles of the present exemplary embodiments to the full extent indicated by the plain meaning of the terms in which the appended claims are expressed.

What is claimed is:

1. A electric charger comprising:
an electric current inputting end being configured for being connected to an external circuit;
at least one electric current outputting end being configured for being connected to at least one electronic product;
a switching circuit, an electric current of the external circuit being varied voltage magnitude and current magnitude by the switching circuit, and being outputted to the at least one electronic product by the at least one electric current outputting end; and
a micro programmed control unit with a smoke concentration preset range and a temperature preset range;
a smoke sensor sensing smoke, generating a smoke concentration value, and transmitting the smoke concentration value to the micro programmed control unit; and
a temperature sensor sensing temperature, generating a temperature value, and transmitting the temperature value to the micro programmed control unit, and the micro programmed control unit contrasting the smoke concentration value against the smoke concentration preset range and contrasting the temperature value against the temperature preset range for controlling the at least one electric current outputting end to be on or off.

2. The electric charger of claim 1, wherein when the smoke concentration value is outside the smoke concentration preset range, or the temperature value is outside the temperature preset range, the micro programmed control unit controls and turns off each electric current outputting end.

3. The electric charger of claim 1, wherein when the smoke concentration value is in the smoke concentration preset range, and the temperature value is in the temperature preset range, the micro programmed control unit does not turn off each electric current outputting end.

4. The electric charger of claim 1, wherein the micro programmed control unit is connected to Internet and wireless network.

5. The electric charger of claim 4 further comprises an Ethernet port connected to the micro programmed control unit.

6. The electric charger of claim 5, wherein Internet is connected to the electric charger by the Ethernet port.

7. The electric charger of claim 4 further comprises a WI-FI module connected to the micro programmed control unit.

8. The electric charger of claim 7, wherein wireless network is connected to the electric charger by the WI-FI module.

9. The electric charger of claim 1 further comprises a loudspeaker connected to the micro programmed control unit.

10. The electric charger of claim 9, wherein the micro programmed control unit transmits a signal of an operational state of the charge to the loudspeaker, the loudspeaker outputs the signal audibly.

11. The electric charger of claim 1 further comprises a microphone connected to the micro programmed control unit.

12. The electric charger of claim 9, wherein the microphone receives a voice of user, generates a controlling signal, and transmits the controlling signal to the micro programmed control unit for controlling the electric current outputting end to be on or off.
